(19) United States
(12) Patent Application Publication
(10) Pub. No.: US 2022/0345515 A1
(43) Pub. Date: Oct. 27, 2022

(54) RECIPIENT DETERMINATION BASED ON FILE CONTENT

(71) Applicant: Citrix Systems, Inc., Fort Lauderdale, FL (US)

(72) Inventors: Ramadas S. Mahale, Bangalore (IN); Divyansh Deora, Jaipur (IN); Anirudh Katoch, New Delhi (IN)

(21) Appl. No.: 17/236,122

(22) Filed: Apr. 21, 2021

(51) Int. Cl. H04L 29/08; H04L 29/06

(52) U.S. Cl. CPC H04L 67/06; H04L 67/306; H04L 67/2804; H04L 67/42

(57) ABSTRACT

A computing system may evaluate contents of a file to determine at least one user identifier for at least one suggested recipient of the file. The computing system may receive an input from a client device that indicates the file is to be shared, and in response to the input, the computing system may send the at least one user identifier to the client device.

### BACKGROUND

Various file sharing systems have been developed that allow users to share files or other data. ShareFile®, offered by Citrix Systems, Inc., of Fort Lauderdale, Fla., is one example of such a file sharing system.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method performed by computing system involves determining an identifier for at least one user based on contents of a file, the identifier being indicative of the at least one user being a potential recipient of the file, receiving an input from a client device, the input indicative that the file is to be shared, and sending data to the client device in response to receipt of the input so as to enable sharing of the file with use of the client device, the data including the identifier.

In some disclosed embodiments, a computing system comprise at least one processor, and at least one computer-readable medium encoded with instruction which, when executed by the at least one processor, cause the computing system to determine an identifier for at least one user based on contents of a file, the identifier being indicative of the at least one user being a potential recipient of the file, receive an input from a client device, the input indicative that the file is to be shared, and send data to the client device in response to receipt of the input so as to enable sharing of the file with use of the client device, the data including the identifier.

In some disclosed embodiments, at least one non-transitory computer-readable medium may be encoded with instructions which, when executed by at least one processor included in a computing system, cause the computing system to determine an identifier for at least one user based on contents of a file, the identifier being indicative of the at least one user being a potential recipient of the file, receive an input from a client device, the input indicative that the file is to be shared, and send data to the client device in response to receipt of the input so as to enable sharing of the file with use of the client device, the data including the identifier.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a diagram of how a system may determine recipients for a file in accordance with the present disclosure;

FIGS. 1B-1C show example user interface screens illustrating input of a request to share a file and display of recipients for the file;

FIG. 2 is a diagram of a network environment in which some embodiments of the present disclosure may be deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like one shown in FIG. 2 may be configured to allow clients access to an example embodiment of a file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6A is a diagram illustrating an example recipient determination service, implemented in a storage system of the file sharing system shown in FIGS. 5A-C, for determining recipients for a file in accordance with some embodiments;

FIG. 6B is a diagram illustrating example components for the potential recipient determination service shown in FIG. 6A in accordance with some embodiments;

FIG. 7 shows an example routine that may be performed by the potential recipient determination service shown in FIG. 6A in accordance with some embodiments;

FIG. 8 shows an example routine that may be performed by a parser engine of the potential recipient determination service shown in FIG. 6B in accordance with some embodiments;

FIG. 9 shows an example routine that may be performed by a named entity recognition engine of the potential recipient determination service shown in FIG. 6B in accordance with some embodiments;

FIG. 10 shows an example routine that may be performed by a user identifier engine of the potential recipient determination service shown in FIG. 6B in accordance with some embodiments;

FIG. 11 shows an example routine that may be performed by a pruning engine of the potential recipient determination service shown in FIG. 6B in accordance with some embodiments; and

FIG. 12 shows an example routine that may be performed by the file sharing system to provide recipients for a shared file in accordance with some embodiments.

### DETAILED DESCRIPTION

For purposes of reading the description of the various embodiments below, the following descriptions of the sections of the specification and their respective contents may be helpful:

Section A provides an introduction to example embodiments of a system for suggesting recipients for a shared filed;

Section B describes a network environment which may be useful for practicing embodiments described herein;

Section C describes a computing system which may be useful for practicing embodiments described herein.

Section D describes embodiments of systems and methods for delivering shared resources using a cloud computing environment;

Section E describes example embodiments of systems for providing file sharing over networks;

Section F provides a more detailed description of example embodiments of the system for suggesting recipients introduced above in Section A; and

Section G describes example implementations of methods, systems/devices, and computer-readable media in accordance with the present disclosure.

### A. Introduction to Illustrative Embodiments of a System for Sharing Files

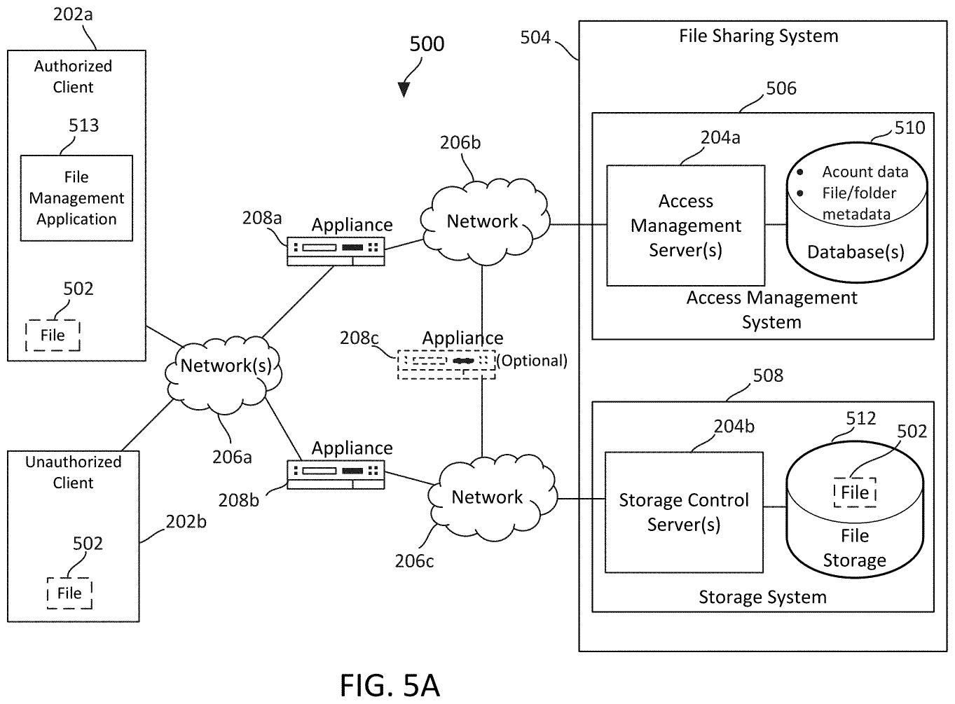

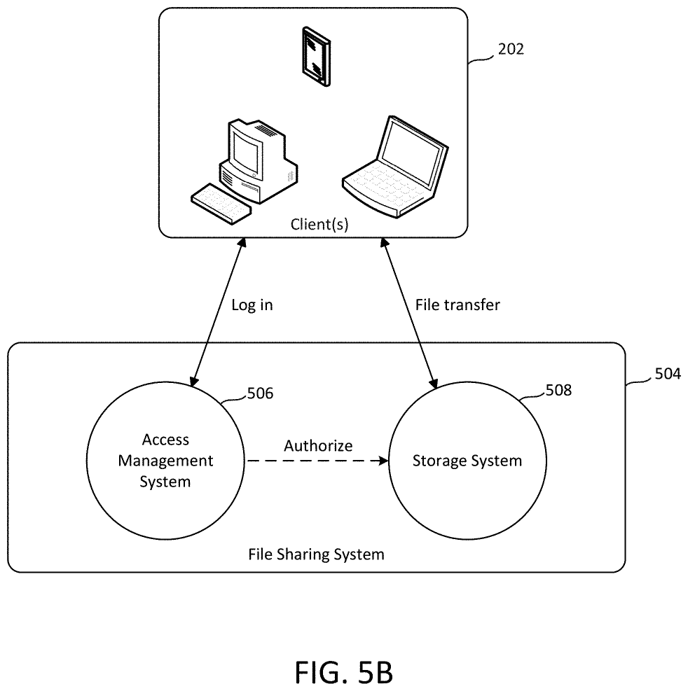

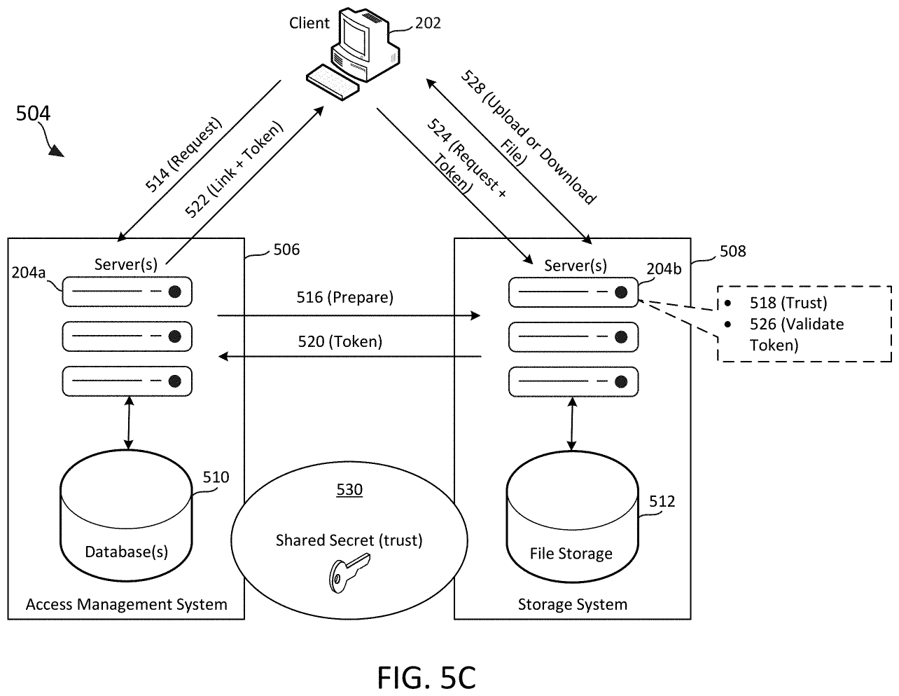

Various file sharing systems have been developed that allow users to share files with other users over a network. An example of such a file sharing system 504 is described below (in Section F) in connection with FIGS. 5A-C. As explained in Section F, in some implementations, one client device 202 may upload a file 502 (shown in FIG. 5A) to a central repository of the file sharing system 504, such as a storage medium(s) 512 shown in FIGS. 5A-C, and another client device 202 may then download a copy of that file 502 from the same repository. As Section F also describes, in some implementations, an access management system 506 may regulate the circumstances in which files 502 may be uploaded and/or downloaded to/from a storage system 508 (including the storage medium 512(s)) by various client devices 202.

In sharing files with other users, a user has to determine the recipients with whom the file is to be shared. In some cases, the number of recipients may be large, and the sharing user may inadvertently neglect to identify one or more of the recipients. In some cases, especially in cross-geographic organizations, the sharing user may misspell the recipient's name or may not know the recipient's email address, making it difficult to find the recipient with whom the file is to be shared. The foregoing can result in a degraded user experience, where the sharing user may be frustrated or may make errors.

The inventors have recognized and appreciated that the file, to be shared, often includes relevant references to one or more potential recipients, such as a person, a team, a group of people, etc., with whom the file can potentially be shared. Offered are systems and techniques for extracting information from a file and determining one or more recipients for the file by processing the extracted information. In some implementations, the systems and techniques may also use information related to an organization (e.g., an organization structure) with which the sharing user and potential recipients are associated and/or may use the sharing user's past communications with other individuals or other information to determine the suggested recipients.

In some implementations, as described in more detail in Section F below, the systems and techniques may be implemented as a potential recipient determination service included in the file sharing system 504, in particular, in the storage system 508. Such implementations may avoid sending the file and/or user information to another server/system, and instead enables such data to remain within the secure file sharing system 504.

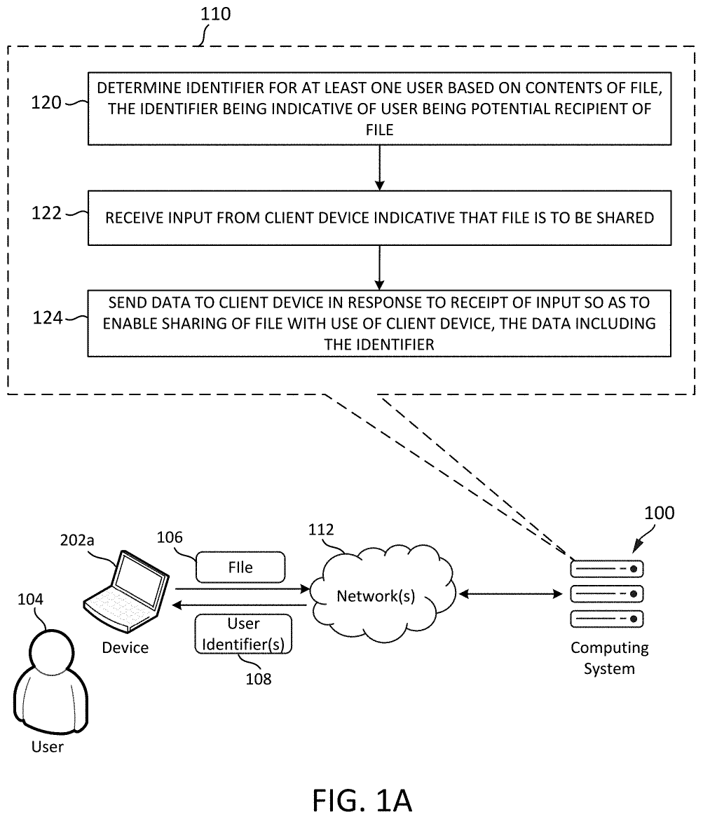

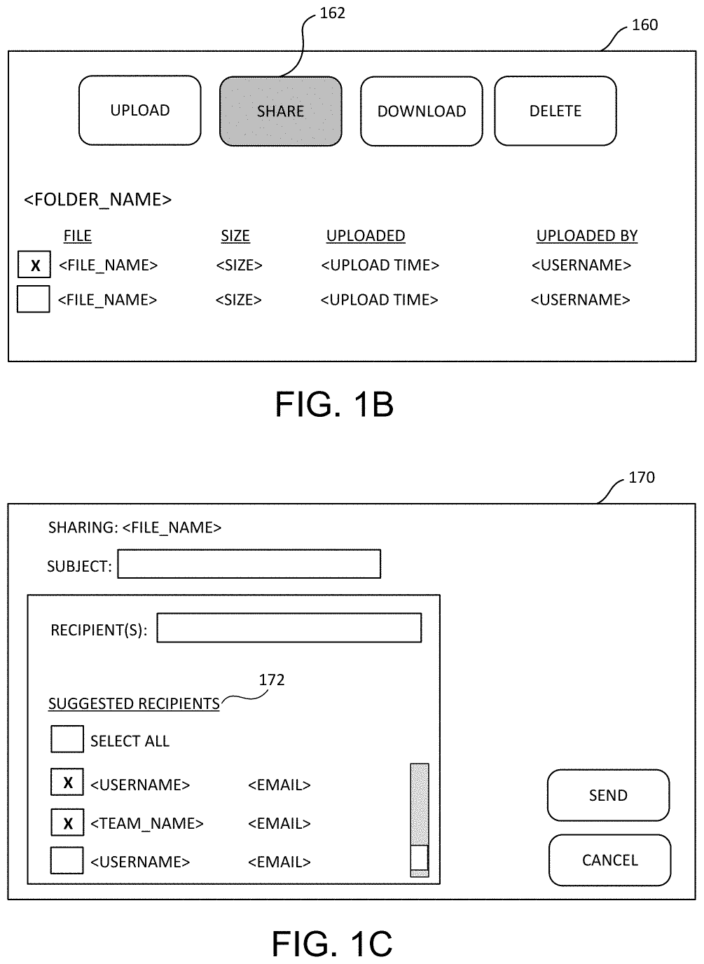

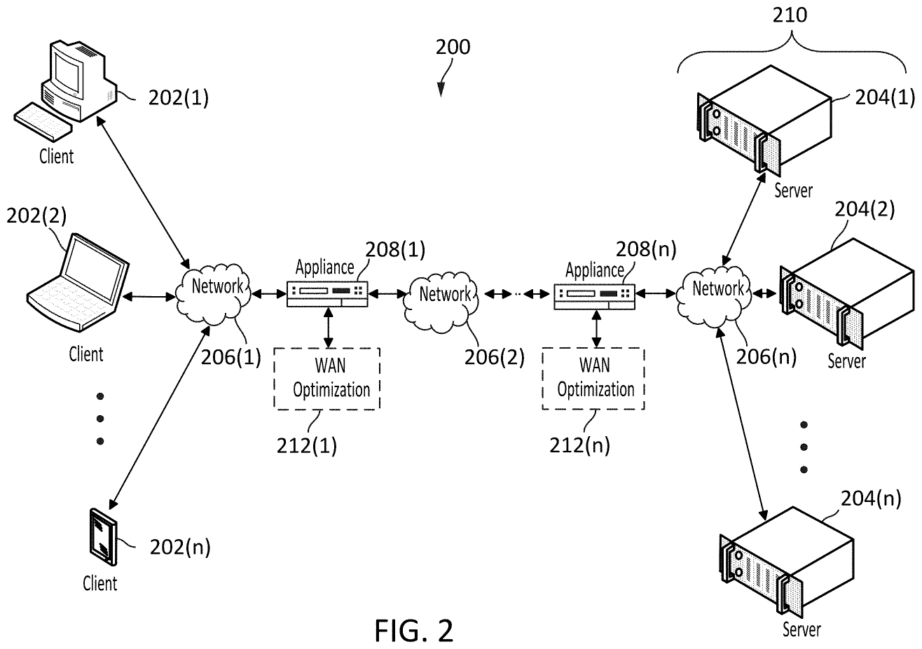

FIG. 1A is a high-level diagram illustrating how a computing system 100 may determine recipients for a file 106 in accordance with some embodiments of the present disclosure. In some embodiments, the computing system 100 may, for example, be part of the file sharing system 504. In some embodiments, the file sharing system 504 may be in communication with the computing system 100. In some embodiments, the computing system 100 may include one or more servers 204 (examples of which are describe below in relation to FIG. 2). The client device 202a may be in communication with the computing system 100 using one or more networks 112. An example routine 110 that may be performed by the computing system 100 is illustrated.

The computing system 100 may receive the file 106 to be shared with one or more recipients. The client device 202a may send the file 106 to the computing system 100 for upload and storage at the computing system 100. In some implementations, a file sharing application may be installed on the client device 202a, and a user 104 may use the file sharing application to upload the file 106 to the computing system 100. In some implementations, the user 104 may use a browser-based file sharing application to upload the file 106 to the computing system 100. The file management application 513 described in Section E (in connection with FIG. 5A) is an example of a file sharing application that may be used for this purpose.

At a step 120 of the routine 110, the computing system 100 may determine an identifier for at least one user based on contents of the file 106, where the identifier may be indicative of the at least one user being a potential recipient of the file 106. In some implementations, the computing system 100 may identify names for one or more persons and/or teams (e.g., named entities) included in the contents of the file 106, and may determine identifiers for the identified persons and/or teams. An identifier, as used herein, may refer to an email address, a username, a group email list (e.g., a list including multiple emails and referred to with a particular name), a user handle (e.g., an identifier, other than a username, used by a user to identify themselves on a platform), or other types of indicators or attributes that can be used to identify a user to which to send a file/data.

In some implementations, the computing system 100 may process other information to determine the identifier(s) for the recipient(s). For example, the computing system 100 may process data from an identity service storage (e.g., a database, such as an active directory) that may store domain information for users of an organization, such as the organization (e.g., company, enterprise, etc.) of the user 104. As a further example, the computing system 100 may process organization structure data that may include information on functional teams of an organization, managers of the organization, members of the teams, and other functional structure information of the organization. As a further example, the computing system 100 may process historic data (e.g., historic correspondence data) for the user 104, which may include past communications with other individuals, such as emails, instant messages, sharing of other files, and other types of communications, between the user 104 and other users. The historic data may include one or more identifiers of the other users that the user 104 may have communicated with.

At a step 122 of the routine 110, the computing system 100 may receive an input from the client device 202a indicative of the file 106 is to be shared. In some implementations, the user 104, via the file sharing application at the client device 202a, may provide an input indicating the user 104 wants to share the file 106. FIG. 1B shows an example user interface screen 160 of such a file sharing application. The user 104 may select a file as shown in FIG. 1B by the checkbox next to the <file_name>, then the user 104 may select a “share” button 162.

At a step 124 of the routine 110, the computing system 100 may send data to the client device 202a in response to receipt of the input (at the step 122) so as to enable sharing of the file 106 with use of the client device 202a, where the data may include the identifier (determined at the step 120). Sending of the data may enable the client device 202a to display the identifier for the at least one potential recipient. In response to the user 104 selecting the “share” button 162, the file sharing application may display the example user interface screen 170 shown in FIG. 1C. The identifier(s), sent by the computing system 100, may be displayed as suggested or potential recipients 172. In some implementations, the user identifier(s) may include a user's name or a team's name, and a corresponding email address (or other identifier).

The user 104 may select one or more of the displayed recipients (e.g., <username>, <team_name>, etc.) using the checkboxes shown in FIG. 1C. The user 104 may also have the option to select all of the recipients shown. In selecting the recipients, the user 104 may select the recipients of the file 106. The user 104 may select a “send” button, shown in FIG. 1C, to send the file 106 to the selected recipients. The file 106 may be shared with the selected recipients via an email message, a notification, or may be otherwise made available to the recipient user via a file sharing application at the recipient's client device (e.g., client device 202b). As described below in Section E, for example, in some implementations, the selected recipients may be provided with access tokens that are embedded within URLs that resolve to an internet protocol (IP) address of the storage system 508, and the client devices 202b may retrieve the file 106 using such token-containing URLs.

In this manner, the computing system 100 may determine recipients, based on information related to the file, with whom the file can potentially be shared.

In some implementations, the client device 202a may determine one or more recipients of a file. For example, the user 104 may provide an input, at the client device 202a, selecting the file 106 for sharing with one or more users, in response to which, the client device 202a may evaluate contents of the file 106 to determine at least one user identifier for at least one recipient of the file 106 (in a similar manner as the step 122 described above). The client device 202a may then display an indication of the user identifier(s) to enable the user 104 to select the user identifier(s) to receive a copy of the file 106.

Additional details and example implementations of embodiments of the present disclosure are set forth below in Section G, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

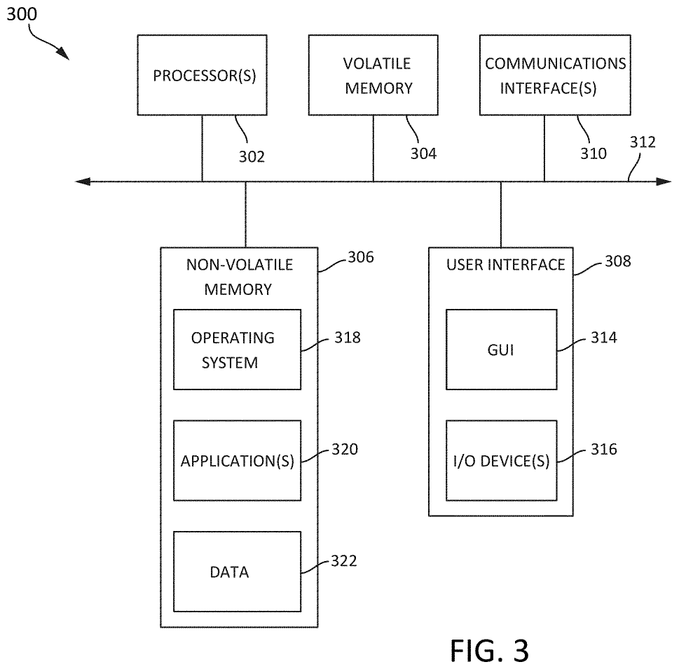

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

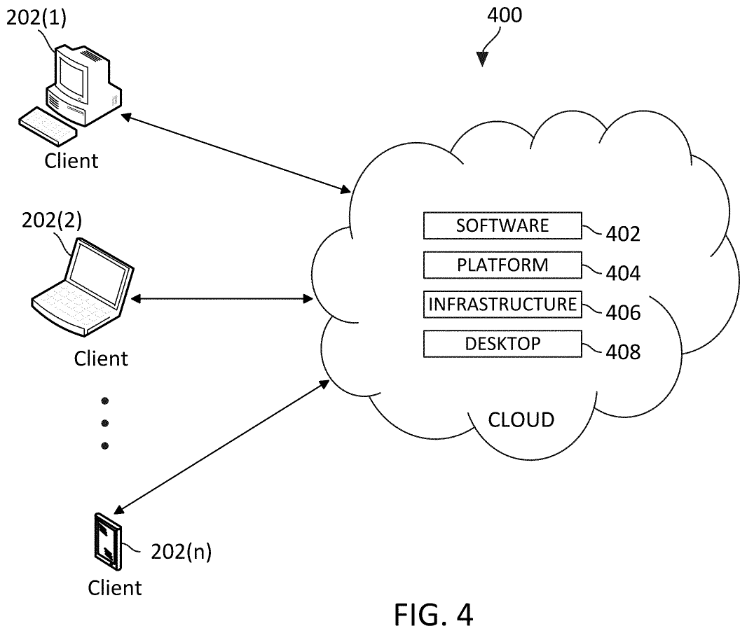

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif. Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

FIG. 5A shows an example network environment 500 for allowing an authorized client 202a and/or an unauthorized client 202b to upload a file 502 to a file sharing system 504 or download a file 502 from the file sharing system 504. The authorized client 202a may, for example, be a client 202 operated by a user having an active account with the file sharing system 504, while the unauthorized client 202b may be operated by a user who lacks such an account. As shown, in some embodiments, the authorized client 202a may include a file management application 513 with which a user of the authorized client 202a may access and/or manage the accessibility of one or more files 502 via the file sharing system 504. The file management application 513 may, for example, be a mobile or desktop application installed on the authorized client 202a (or in a computing environment accessible by the authorized client). The ShareFile® mobile app and the ShareFile® desktop app offered by Citrix Systems, Inc., of Fort Lauderdale, Fla., are examples of such preinstalled applications. In other embodiments, rather than being installed on the authorized client 202a, the file management application 513 may be executed by a web server (included with the file sharing system 504 or elsewhere) and provided to the authorized client 202a via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium(s) 512. In some embodiments, the access management server(s) 204a may, for example, allow a user of the file management application 513 to log in to his or her account, e.g., by entering a user name and password corresponding to account data stored in the database 510. Once the user of the client 202a has logged in, the access management server 204a may enable the user to view (via the authorized client 202a) information identifying various folders represented in the storage medium(s) 512, which is managed by the storage control server(s) 204b, as well as any files 502 contained within such folders. File/folder metadata stored in the database 510 may be used to identify the files 502 and folders in the storage medium(s) 512 to which a particular user has been provided access rights.

In some embodiments, the clients 202a, 202b may be connected to one or more networks 206a (which may include the Internet), the access management server(s) 204a may include webservers, and an appliance 208a may load balance requests from the authorized client 202a to such webservers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202a, 202b are shown is FIG. 5A as stand-alone computers, it should be appreciated that one or both of the clients 202a, 202b shown in FIG. 5A may instead represent other types of computing devices or systems that can be operated by users. In some embodiments, for example, one or both of the authorized client 202a and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202a, 202b received from the network(s) 206a (which may include the Internet) to the storage control server(s) 204b. In some embodiments, the storage control server(s) 204b and/or the storage medium(s) 512 may be hosted by a cloud-based service provider (e.g., Amazon Web Services™ or Microsoft Azure™). In other embodiments, the storage control server(s) 204b and/or the storage medium(s) 512 may be located at a data center managed by an enterprise of a client 202, or may be distributed among some combination of a cloud-based system and an enterprise system, or elsewhere.

After a user of the authorized client 202a has properly logged in to an access management server 204a, the server 204a may receive a request from the client 202a for access to one of the files 502 or folders to which the logged in user has access rights. The request may either be for the authorized client 202a to itself to obtain access to a file 502 or folder or to provide such access to the unauthorized client 202b. In some embodiments, in response to receiving an access request from an authorized client 202a, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202a, and the authorized client 202a may then send a request for a file 502, including the token, to the storage control server(s) 204b. In other implementations, the authorized client 202a may send the generated token to the unauthorized client 202b so as to allow the unauthorized client 202b to send a request for the file 502, including the token, to the storage control server(s) 204b. In yet other implementations, an access management server 204a may, at the direction of the authorized client 202a, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202a to send a request to the URL address, or by sending an email, text message or other communication including the token-containing URL to the unauthorized client 202b, either directly from the access management server(s) 204a or indirectly from the access management server(s) 204a to the authorized client 202a and then from the authorized client 202a to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202a or an unauthorized client 202b to upload a file 502 to a folder corresponding to the token. In some embodiments, for example, an “upload” token can be generated as discussed above when an authorized client 202a is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user's that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium(s) 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

### F. Detailed Description of Example Embodiments of System for Sharing Files

As described above in Section A, at a high level, the computing system 100 (shown in FIG. 1A) may determine suggested or potential recipients for a file (e.g., the file 106 shown in FIG. 1A) by processing contents of the file, and may send information, such as user identifiers, for the recipients to the client device 202 to enable display of the recipients as well as to enable selection of one or more of the recipients by the user 104 at the client device 202. In some implementations, the user 104 may upload the file 106 to the computing system 100 using a file sharing application (e.g., the file management application 513 described in Section F above in connection with FIG. 5A) at the client device 202a.

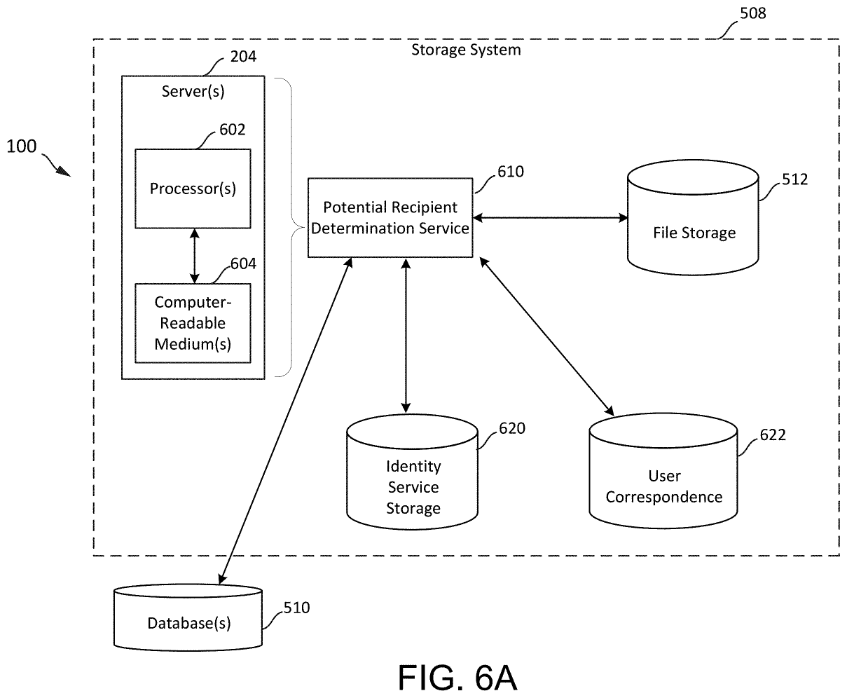

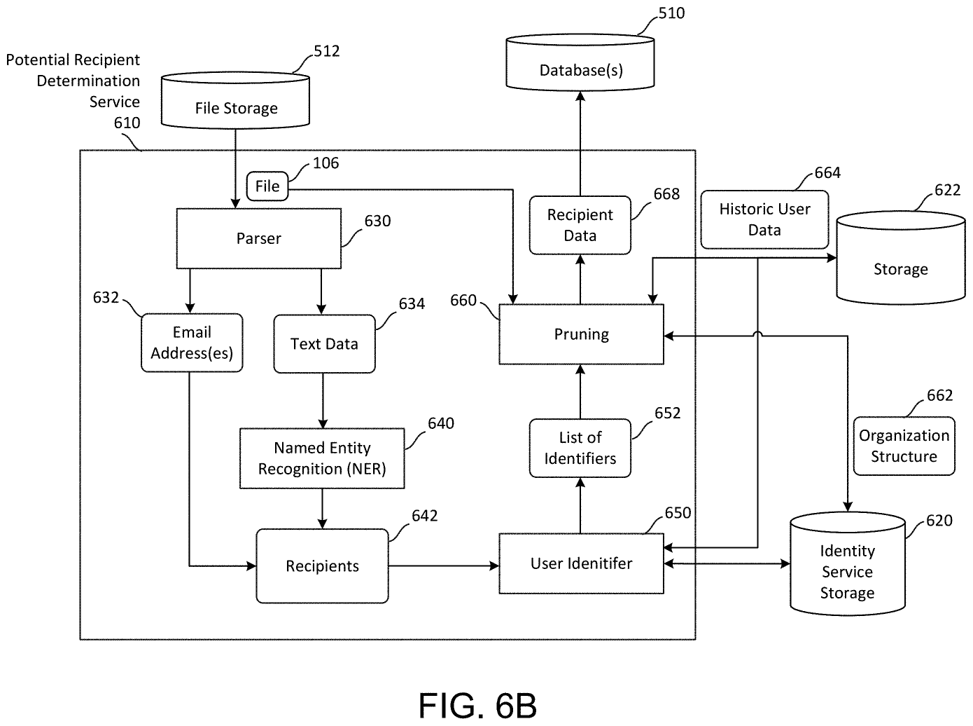

FIG. 6A illustrates a more detailed example implementation of the computing system 100 introduced in Section A. As shown, in some implementations, the computing system 100 may include a potential recipient determination service 610 which may, for example, be embodied by one or more servers 204. As illustrated, such server(s) 204 may include one or more processors 602 as well as one or more computer-readable mediums 604 that are encoded with instructions to be executed by the processor(s) 602. In some implementations, such instructions may cause the processor(s) 602 to implement one or more, or possibly all, of the operations of the potential recipient determination service 610 described herein. As illustrated by the dashed line in FIG. 6A, in some implementations, the potential recipient determination service 610 may be implemented as a part of the storage system 508 of the file sharing system 504 (shown in FIGS. 5A-C). In other implementations, the potential recipient determination service 610 may be implemented outside of the file sharing system 504, and the file sharing system 504 may be in communication with the potential recipient determination service 610. In yet other implementations, the potential recipient determination service 610 may be implemented outside of the storage system 508 within a different component or as a separate component of the file sharing system 504. The potential recipient determination service 610 may be configured to determine suggested recipients for the file 106.

In some implementations, the computing system 100 may store a tag or other metadata, associated with or otherwise assigned to the file 106, indicating an identifier for a recipient for the file 106. As used herein, a tag may be a keyword, a term or other data associated with or assigned to a file. In some implementations, these tags may be stored by the file sharing system 504 in the storage medium(s) 510 of the access management system 506 of the file sharing system 504 (shown in FIGS. 5A-5C). As described above, the storage medium(s) 510 may store metadata for files stored at the storage medium(s) 512 of the storage system 508. In other implementations, the computing system 100 may store the tag or other metadata in another storage of the file sharing system 504 or in a storage outside of the file sharing system 504.

FIG. 6B shows example components that may employed within the potential recipient determination service 610. As shown, in some implementations, the potential recipient determination service 610 may include a parser engine 630, a named entity recognition (NER) engine 640, a user identifier engine 650, and a pruning engine 660. As noted above, some or all of those engines may be implemented, for example, by the processor(s) 602 and computer-readable medium(s) 604 of the server(s) 204 shown in FIG. 6A.

The processor(s) 602 and computer-readable medium(s) 604, and the respective functional engines 630, 640, 650 and 660, embodied by those components, may be disposed at any of a number of locations within a computing network such as the network environment 200 described above (in Section B) in connection with FIG. 2. The storage medium(s) 510, 512, 620, and 622 shown in FIG. 6B may likewise be disposed at any of a number of locations within such a computing network in a distributed architecture or other fashion. In some implementations, for example, the processor(s) 602 and the computer-readable medium(s) 604 embodying one or more such components may be located within one or more of the servers 204 and/or the computing system 300 that are described above (in Sections B and C) in connection with FIGS. 2 and 3, and/or may be located within a cloud computing environment 400 such as that described above (in Section D) in connection with FIG. 4. In some implementations, one or more of the functional engines 630, 640, 650, 660 and/or the storage medium(s) 510, 512, 620, and 622 may additionally or alternatively be disposed within a file sharing system, such as the file sharing system 504 described above in connection with FIGS. 5A-5C. In some embodiments, the functional engines 630, 640, 650, 660 may operate in conjunction with or within, the storage system 508 described above (in Section E) in connection with FIGS. 5A-5C.

As shown in FIGS. 6A and 6B, the potential recipient determination service 610 may be in (wired or wireless) communication with one or more storage mediums, such as the storage medium(s) 512 (of the storage system 508 of the file sharing system 504), the database(s) 510 (of the access management system 506 of the file sharing system 504), an identity service storage 620, and a user correspondence storage 622.

As described above in (Section E) in connection with FIGS. 5A-5C, the storage medium(s) 512 may store files 502 uploaded to the file sharing system 504 by multiple different users, including the file 106 which may be uploaded by the user 104. As described above in (Section E) in connection with FIGS. 5A-5C, the database(s) 510 may store information used to process user requests, and may store file metadata, such as tags, associated with the files 502. One of the user requests may be a request to share the file 106 with one or more other users, and one of the types of information stored in the database(s) 510 may be tags indicating identifiers for recipients of the file 106.

The identity service storage 620 may store information (e.g., user account information, access policies, etc.) to control access to resources (e.g., domain access) for an organization (e.g., an employer of the user 104). The identity service storage 620, in some implementations, may be part of an active directory (AD) service for the organization. The AD service may authenticate and authorize users and devices in a domain type network, while assigning and enforcing security policies. For example, when the user 104 logs into the client device 202a that is part of the organization's domain network, the AD service may check the submitted password to authenticate the user 104, and may also determine the type of access the user 104 has (e.g., a system administrator, a user of a particular team, etc.). The identity service storage 620 may also store information related to the organization's functional structure and the users' functional roles. For example, the identity service storage 620 may store information indicating the different teams of the organization, the members/users within the teams, the managers of the teams, each user's job title, office location, etc. The potential recipient determination service 610 may communicate with the identity service storage 620 to retrieve user identifiers (e.g., email addresses, email aliases, user handles, email group list, etc.) for users of the organization, and to retrieve organization structure data.

The user correspondence storage 622 may store information related to communications among individuals. For example, the user correspondence storage 622 may store emails received by/sent by the user 104 from/to users of the organization and users outside of the organization. The stored information may relate to emails, instant messages, file share requests, and other type of communications. The stored information may at least include a person's name or team name with whom the user 104 communicated with. The stored information may also include an identifier (e.g., an email address, an email alias, a user handle, an email group list, etc.) for the person or the team that the user 104 communicated with. The user correspondence storage 622 may store the information based on any storage policies set by the user 104, and in accordance with any storage permissions provided by the user 104.

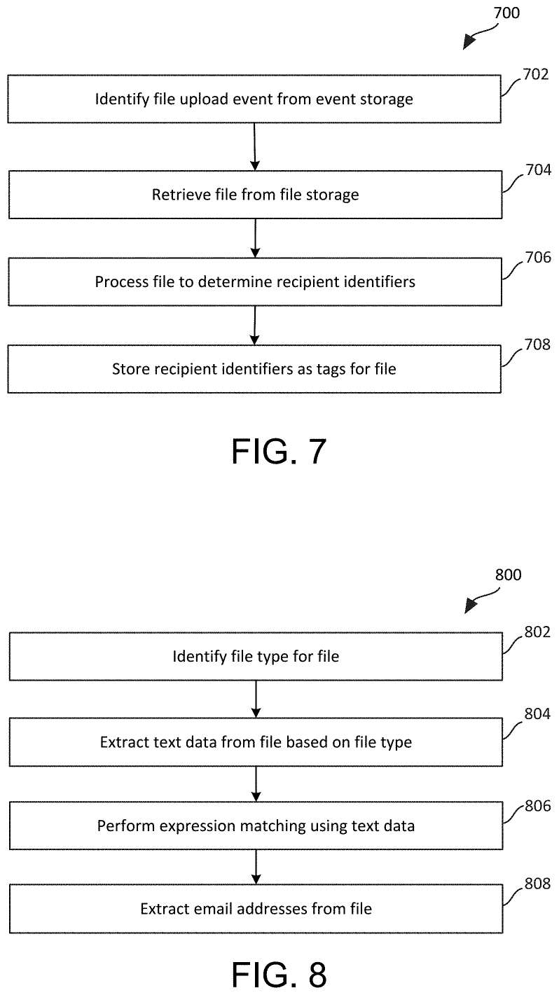

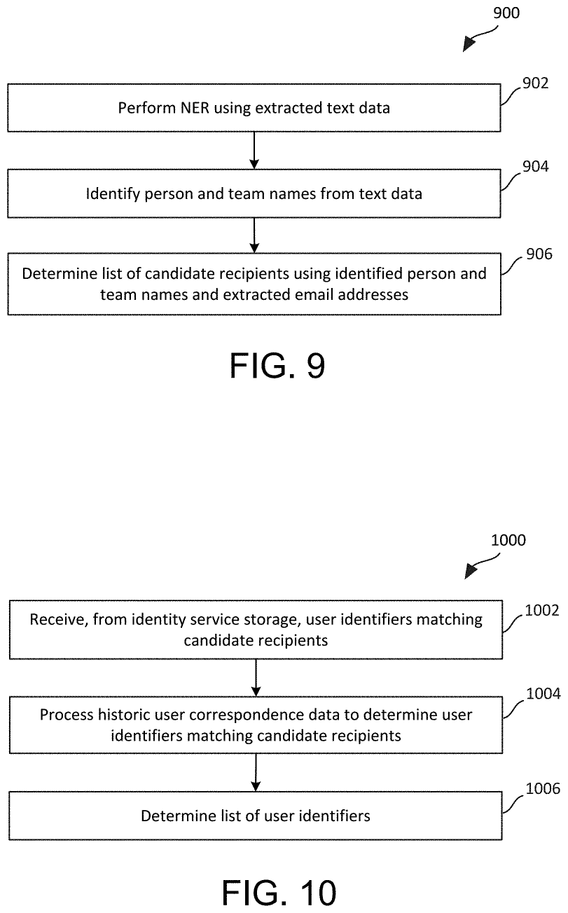

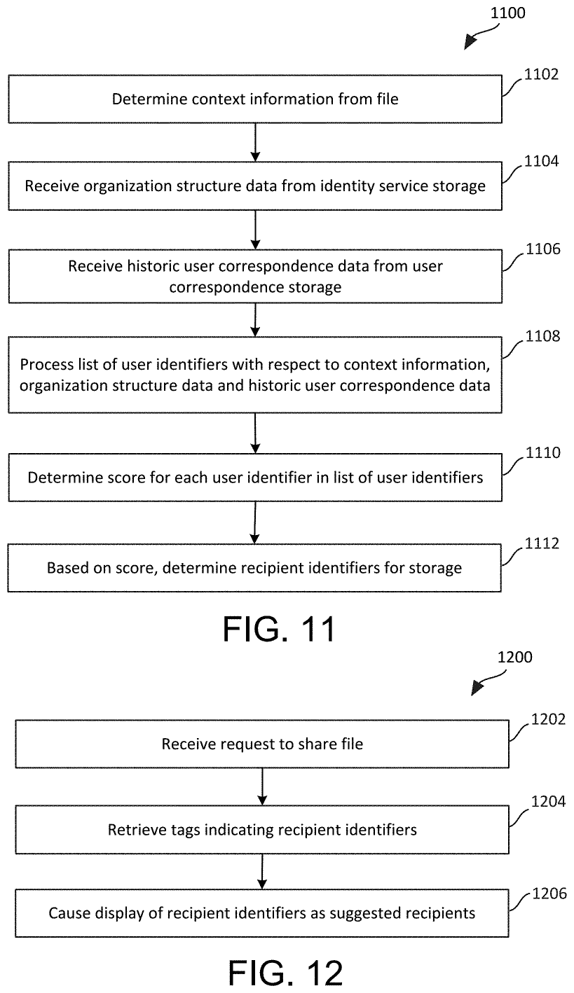

FIG. 7 shows an example routine 700 that may be performed by the potential recipient determination service 610 to process the file 106 uploaded to the computing system 100. FIG. 8 shows an example routine 800 that may be performed by the parser engine 630 of the potential recipient determination service 610 to determine text data from the file 106. FIG. 9 shows an example routine 900 that may be performed by the NER engine 640 of the potential recipient determination service 610 to identify named entities from the file contents. FIG. 10 shows an example routine 1000 that may be performed by the user identifier engine 650 of the potential recipient determination service 610 to determine user identifiers for named entities identified from the file contents. FIG. 11 shows an example routine 1100 that may be performed by the pruning engine 660 of the potential recipient determination service 610 to determine suggested recipients for the file 106. FIG. 12 shows an example routine 1200 that may be performed by the file sharing system 504 to provide suggested recipients in response to a request to share the file 106.

In some implementations, the potential recipient determination service 610 may process files after they are uploaded to the file sharing system 504. Referring to FIG. 7, in some implementations, the potential recipient determination service 610 may identify, at a step 702 of the routine 700, a file upload event from an event storage at the file sharing system 504. The user 104 may send the file 106, using the file sharing application at the client device 202a, to the file sharing system 504 for upload, and the file sharing system 504 may store the received file 106 in the storage medium(s) 512. Once the file 106 is successfully uploaded, the file sharing system 504 may publish or otherwise create the file upload event, which may be stored in the event storage (or an event bus). One or more components of the file sharing system 504 may identify or otherwise listen for particular events. For example, the potential recipient determination service 610 may include an event handler that may identify or otherwise listen for the file upload event.

At a step 704 of the routine 700, the potential recipient determination service 610 may retrieve the file 106 from the storage medium(s) 512. In some implementations, the file upload event may identify the file 106 using an attribute or other characteristic of the file, which the potential recipient determination service 610 may use to retrieve the file 106.

At a step 706 of the routine 700, the potential recipient determination service 610 may process the file 106 to determine one or more recipients (e.g., recipient data 668 shown in FIG. 6B) of the file 106. The potential recipient determination service 610 may process the file 106 to determine one or more recipients as described in detail in relation to FIGS. 8-11 using the functional engines shown in FIG. 6B. The recipient data 668, in some implementations, may be an identifier(s) for a recipient such as a username, an email address, a user handle for a messaging platform, or other identifiers that can be used to communicate with the recipient to send a file (or other data) to the recipient.

At a step 708 of the routine 700, the potential recipient determination service 610 may store the recipient data 668 as tags (or other forms of metadata) for the file 106. In some implementations, the recipient data 668 may be stored as tags for the file 106 in the storage medium(s) 510 of the access management system 506. In this manner, the potential recipient determination service 610 may process a file after it is uploaded to the file sharing system 504 to determine suggested or potential recipients of the file, and the recipient identifiers may be stored for later use when the user 104 may provide a request (e.g., a share request) to share the file. In other implementations, the potential recipient determination service 610 may process a file to determine recipients (as described in detail in relation to FIGS. 8-11) in response to receiving a request to share the file, rather than in response to the file being uploaded.

Referring to FIG. 8, at a step 802 of the routine 800, the parser engine 630 may identify a file type for the file 106. The parser engine 630 may receive the file 106 retrieved from the storage medium(s) 512, as shown in FIG. 6B. The parser engine 630 may identify the file type using a file extension of the file 106, such as, .doc, .pdf, .ppt, .jpg, .mov, .cad, etc. The parser engine 630 may, alternatively or additionally, identify the file type using a file signature of the file 106. The parser engine 630 may determine the file signature by analyzing the bytes (e.g., the first four bytes) of the file 106 typically used to designate the file type. In some implementations, the parser engine 630 may analyze such bytes using a hex editor, and may compare the ASCII representation of the bytes with stored data (e.g., a table) indicating which ASCII code corresponds with which file type.

At a step 804 of the routine 800, the parser engine 630 may extract text 634 from the file 106 based on the file type. Most file types are readable in a programmatic manner due to their well-defined structure and details available in the public domain. For example, a .ppt file may be an archive of XMLs, where individual XMLs may describe the contents of a slide, slide notes, slide animation, etc., within which the rendered text is contained in tags. Based on the file type and the corresponding file structure, the parser engine 630 may extract some or all the text from the file 106 and output it as the text data 634. Some file types may be directly consumable by common programming languages via system libraries, and the parser engine 630 may use one or more functions to extract the text from the file 106. The parser engine 630 may select an appropriate function, to extract the text, based on the file type of the file 106. In some implementations, the parser engine 630 may use optical character recognition (OCR) to determine text from images and videos. In some implementations, the parser engine 630 may use automatic speech recognition (ASR) to determine text from audio files.

In some implementations, where the file type is unknown or the parser engine 630 does not have access to a function that can be used to extract text from the file, then the parser engine 630 may determine the content 634 of the file in the form of text using the textual information contained in the Unicode UTF-8 for the file 106. The parser engine 630 may filter the textual information extracted from the Unicode based on a list (e.g., a predefined list) to filter out certain strings/text relating to structure and format information for the file 106 and to retain text that relates to the contents of the file 106.

At a step 806 of the routine 800, the parser engine 630 may perform expression matching using the text data 634. The parser engine 630 may be configured to search for a set of characters (expression) corresponding to information about a user (e.g., an email other address type) within the text data 634. For example, the parser engine 630 may be configured to search for “@”, “@*.com”, “@*.org”, etc. where the asterisk may refer to multiple characters. In some implementations, the parser engine 630 may use regular expression (regex) matching to identify strings/portions of the text data 634 that match information about a user. The parser engine 630 may be configured to search for other set of characters that may relate to information other than an email address.

Based on the expression matching at the step 806, at a step 808 of the routine 800, the parser engine 630 may extract one or more information (e.g., an email addresses 632) from the file 106. The parser engine 630 may store text that are identified as email addresses in a list or table 632. Thus, the list 632 may include the email addresses from the contents of the file.

Referring to FIG. 9, at a step 902 of the routine 900, the NER engine 640 may process the extracted text 634. The NER engine 640 may employ one or more machine learning models or other techniques to perform named entity recognition. The machine learning models and other techniques of the NER engine 640 may be trained (or fine-tuned) on a data set including person's names from various geographic regions. The NER engine 640 may perform part-of-speech tagging and may identify segments of the text data 634 as the appropriate part of speech, for example, noun, pronoun, adjective, determiner, verb, adverb, preposition, conjunction, or interjection.

At a step 904 of the routine 900, the NER engine 640 may identify person and team names from the text data 634. Based on the processing at the step 902 (e.g., performing part-of-speech tagging), the NER engine 640 may identify segments in the text data 634 that are proper nouns such as a person's first name, a person's last name, and a team's name. The NER engine 640, in some implementations, may be configured to filter the identified proper nouns to filter out famous names (e.g., celebrities, politicians, etc.). For filtering, the NER engine 640 may use a list of proper nouns.

At a step 906 of the routine 900, the potential recipient determination service 610 may determine recipients 642 using the identified persons and team names and the extracted email addresses 632. The NER engine 640 may output a list including the persons and team names identified by the NER engine 640 from the file contents. The potential recipient determination service 610 may combine the list from the NER engine 640 with the email addresses 632 to determine the recipients 642. Thus, the recipients 642 may be names and email addresses included in the contents of the file 106.

Referring to FIG. 10, at a step 1002 of the routine 1000, the user identifier engine 650 may receive, from the identity service storage 620, a list of identifiers indicative of users matching one or more of recipients 642. The engine 650 may send a request/call to the identity service storage 620 for identifiers matching the candidate recipients 642. The identity service storage 620, as described above, may store domain information for users of an organization, where the user 104 may be associated with the organization. In response to the request/call, the identity service storage 620 may search the domain information for a recipient, and if found, then output corresponding information, such as, username or team name, and a user identifier. The user identifier may be an email address (or email alias, a user handle, or other identifier) for a person or a team. The identifier may also be an email group list that includes multiple email addresses (e.g., an email group list may be “team_1” and may include multiple email addresses for individual users. Sending an email to “team_1” may send an email to each of the email addresses of the individual users). The identity service storage 620 may send user identifiers for any of the candidate recipients 642 that are found.

At a step 1004 of the routine 1000, the user identifier engine 650 may process historic user data 664 to determine identifiers matching one or more of the recipients 642. The user identifier engine 650 may retrieve from storage 622 the historic user data 664, which may include one or more communications between the user 104 and other individuals. Such messages may be emails, instant messages, communications sharing files (e.g., using the file sharing application), and other types of correspondence. The historic user correspondence data 664 may include user identifiers for persons and teams that the user 104 has previously communicated with, including persons outside of the organization of the user 104. Thus, using the historic user correspondence data 664, the user identifier engine 650 may also identity user identifiers for persons outside of the user's 104 organization.

At a step 1006 of the routine 1000, the user identifier engine 650 may determine a list of identifiers 652. Using the identifiers identified from the identity service storage 620 and storage 622, the user identifier engine 650 may generate the list of identifiers 652 (e.g., by combining the identifiers identified from the identity service storage 620 and the storage 622). The list of identifiers 652 may also include names of the persons or teams for the respective identifier.

The pruning engine 660 may rank/filter the list of identifiers 652 using various data. Referring to FIG. 11, at a step 1102 of the routine 1100, the pruning engine 660 may determine context information from the file 106. The pruning engine 660 may be configured to determine context information related to where the recipients (e.g., person names, team names, and email addresses) are found in the file 106. In determining the context information, the pruning engine 660 may use the type of contents and the structure of the contents contained in the file 106. For example, the file 106 may be an academic paper, which typically lists authors of the paper at the beginning. The pruning engine 660 may determine context information, in this example, to indicate that one or more of the recipients 642 is found at the beginning of the file 106. In another example, the file 106 may be a spreadsheet including work hours for a team of employees, and may also include names of the team's managers and supervisors. The file 106 may include a title row and title column indicating which names are of employees and which names are of managers and supervisors. In this example, the pruning engine 660 may determine the context information to indicate that some of the recipients are indicated as managers and supervisors in the file 106, while some of the other recipients are indicated as employees. The pruning engine 660 may determine separate context information for individual recipients 642. In other implementations, the pruning engine 660 may determine general context information for the file 106. In some implementations, the pruning engine 660 may employ one or more machine learning models or other techniques to determine the context information from the file 106. Such machine learning models and other techniques may be trained/configured using different types of files (e.g., academic papers, financial files, legal files, human resources files, meeting agenda files, presentation files, etc.) that may be labeled/annotated with named entities of interest and their corresponding context information.

At a step 1104 of the routine 1100, the pruning engine 660 may receive organization structure data 662 from the identity service storage 620. The organization structure data 662 may include information for the user's 104 organization, such as, team names, members of the teams, users' job titles/roles, etc. The pruning engine 660, in some examples, may send a request for the organization structure data 662 to the identity service storage 620 to enable engine 660 to receive the data 662.

At a step 1106 of the routine 1100, the pruning engine 660 may receive the historic user data 664 from the user correspondence storage 622. The historic user data 664 may include information related to the user's 104 past communications with other individuals (within the organization or outside of the organization). The pruning engine 660 may send a request for data, where the request may include an identifier (e.g., a user id or a username) for the user 104, the user correspondence storage 622 may retrieve the historic user data 664 corresponding to the user 104, and send the historic user data 664 to the pruning engine 660.

At a step 1108 of the routine 1100, the pruning engine 660 may process the list of identifiers 652 with respect to the context information, the organization structure data 662 and the historic user data 664. In some implementations, the pruning engine 660 may use one or more machine learning models or other techniques to process the list of user identifiers 652. The pruning engine 660 may use a different machine learning model and technique to process the list of identifiers 652 with respect to the different mentioned data. For example, the pruning engine 660 may use a first machine learning model and technique to process the list of user identifiers 652 and the context information, a second machine learning model and technique to process the list of user identifiers 652 and the organization structure data 662, and a third machine learning model and technique to process the list of user identifiers 652 and the historic user correspondence data 664. In other implementations, the pruning engine 660 may process the list of user identifiers 652 with respect to the mentioned data using the same machine learning model(s) and technique.

In processing the list of user identifiers 652 with respect to the mentioned data, the pruning engine 660 may determine how likely an identifier in the list 652 is a recipient of the file 106 based on the context information, the organization structure data 662 and the historic user data 664. For example, a first identifier in the list 652 may be likely to be a recipient of the file 106 based on the context information indicating that the recipient is found in the beginning of the file contents. As another example, a second identifier in the list 652 may be likely to be a recipient of the file 106 based on the organization structure data 662 indicating that the recipient is a manager of the user 104.

Based on the processing in the step 1108, at a step 1110 of the routine 1100, the pruning engine 660 may determine a score for individual identifiers in the list of identifiers 652. The score may indicate a likelihood/probability of a user indicated by the identifier being a recipient of the file 106. In some implementations, the score may be a numerical value between 0 and 1. In other implementations, the score may be a numerical value between a different range, such as, 0 to 100, 0 to 1000, etc. In some implementations, the pruning engine 660 may determine a different score based on processing the identifier in the list 652 with respect to the different mentioned data, and then determine a composite/combined score for the user identifier. For example, the pruning engine 660 may determine a first score indicating a first likelihood/probability of a user associated with an identifier being a recipient of the file 106 based on the context information, a second score indicating a second likelihood/probability of another user with a different identifier being a recipient of the file 106 based on the organization structure data 662, and a third score indicating a third likelihood/probability of yet another user associated with another different identifier being a recipient of the file 106 based on the historic user data 664. The pruning engine 660 may determine a composite/combined score using the first score, the second score and the third score, for example, by determining a sum of the scores, an average of the scores, a weighted average of the scores, a mean of the scores, a median of the scores, etc. In other implementations, the pruning engine 660 may determine a single score based on processing the identifier in the list 652 with respect to some or all the mentioned data.

At a step 1112 of the routine 1100, the pruning engine 660, based on the score, may determine recipients. The pruning engine 660 may filter/rank or otherwise classify the list of identifiers 652 based on the determined score to determine the recipients. In some implementations, the pruning engine 660 may filter the list of user identifiers 652 by determining which of the user identifiers have scores that satisfy a threshold (e.g., a specific value). The identifiers in the list 652 that have scores satisfying (e.g., equal to or above) the threshold may be stored as recipients. In other implementations, the pruning engine 660 may rank the list of identifiers 652 based on their respective scores, and may determine the top-k (e.g., top five or top ten) scoring identifiers as recipients. The pruning engine 660, in some implementations, may send the recipient data 668 to the database(s) 510 for storing as tags or other forms of metadata for the file 106.

In this manner, the potential recipient determination service 610 may determine recipient data 668 for recipients for the file 106, and may store the recipient data 668 for later use in response to a share request as described in relation to FIG. 12. Referring to FIG. 12, at a step 1202 of the routine 1200, the file sharing system 504 may receive a request to share the file 106. The user 104 may provide an input via the file sharing application at the client device 202a (as illustrated in FIG. 1B) indicating the user 104 wants to share the file 106. At a step 1204 of the routine 1200, the file sharing system 504 may retrieve tags or other metadata, for the file 106, indicating identifiers of recipients. The file sharing system 504 may retrieve the tags or other metadata from the database(s) 510 in response to receiving the share request. At a step 1206 of the routine 1200, the file sharing system 504 may cause display of the recipient identifiers as suggested or potential recipients. The file sharing system 504 may send data to the client device 202a to enable display of the recipient identifiers, along with other information such as username or team name, via the file sharing application (e.g., as illustrated in FIG. 1C).

In this manner, the file sharing system 504 may process contents of an uploaded file to determine and store suggested recipients for the file, and retrieve the stored suggested recipients for display in response to a share request. Operations similar to that described above may be used to process contents of a file in response to receiving a share request for the file, rather than in response to the file being uploaded. That is, the file sharing system 504 (or the computing system 100) may receive a file along with a request to share the file with other users, may process the contents of the file to determine suggested recipients, and cause display of the suggested recipients.

The user 104 may select one or more of the suggested recipients to receive the file 106. The user 104 may additionally or alternatively provide one or more recipients that is not in the list of suggested recipients. In some implementations, the file sharing system 504 may update the tags or metadata for the file 106 to include user identifiers for the recipient(s) that the user 104 enters not suggested by the system. In some implementations, the potential recipient determination service 610 may update/retrain one or more of the functional engines 630, 640, 650, and 660 based on the recipient(s) entered by the user 104.

The computing system 100 may request permission/authorization from the user 104 to process contents of the file 106 (or other files the user 104 may upload or share) as described above to determine the suggested recipients. One or more of the operations described herein may be performed by the computing system 100 in accordance with permissions provided by the user 104 and in compliance with all appropriate laws in various jurisdictions, regulations, standards, and the like.

G. Example Implementations of Methods, Systems, and Computer-Readable Media in Accordance with the Present Disclosure

The following paragraphs (M1) through (M11) describe examples of methods that may be implemented in accordance with the present disclosure.

(M1) A method may involve determining, by a computing system, an identifier for at least one user based on contents of a file, the identifier being indicative of the at least one user being a potential recipient of the file, receiving, by the computing system, an input from a client device, the input indicative that the file is to be shared, and sending, by the computing system, data to the client device in response to receipt of the input so as to enable sharing of the file with use of the client device, the data including the identifier.

(M2) A method may be performed as described in paragraph (M1), and may further involve receiving, by the computing system and from the client device, the file, and generating, by the computing system, an event indicating upload of the file to the computing system.

(M3) A method may be performed as described in paragraph (M2), wherein the identifier for the at least one user is determined in response to the event being generated.

(M4) A method may be performed as described in any of paragraphs (M1) through (M3), and may further involve storing, by the computing system, metadata associating the at least one user identifier with the file, and retrieving the metadata after receipt of the input.

(M5) A method may be performed as described in any of paragraphs (M1) through (M4), and may further involve determining text of the file, identifying, from the text, one or more named entities corresponding to a person name or a team name, and determining the identifier based on the one or more named entities.

(M6) A method may be performed as described in any of paragraphs (M1) through (M5), and may further involve identifying, by the computing system, one or more named entities from the contents of the file, sending, to a database, a request for identifiers that match the one or more named entities, and in response to the request, receiving, from the database, a list of identifiers including the identifier.

(M7) A method may be performed as described in paragraph (M6), and may further involve determining, by the computing system, a subset of identifiers from the list of identifiers based on an order of the list of identifiers.

(M8) A method may be performed as described in any of paragraphs (M1) through (M7), and may further involve determining, by the computing system, historic data for a user of the client device, the historic data including at least one recipient user that received a correspondence from the user, and determining, by the computing system, the identifier based on the contents of the file and the historic data.

(M9) A method may be performed as described in any of paragraphs (M1) through (M8), and may further involve identifying, by the computing system, an organization of at least one team name and one or more users associated with the organization, and determining, by the computing system, the identifier based on the contents of the file, the organization, and the one or more users.

(M10) A method may be performed as described in any of paragraphs (M1) through (M9), and may further involve determining, by the computing system, a file type for the file, and determining, by the computing system, the at least one user identifier based on the contents of the file and the file type.

(M11) A method may be performed as described in any of paragraphs (M1) through (M10), and may further involve identifying, by the computing system, one or more named entities from the contents of the file, determining, by the computing system, a list of user identifiers matching the one or more named entities, determining a score for at least one identifier in the list of identifiers based on at least one of a characteristic of the file, a file type of the file, context for the one or more named entities, organization structure data for an organization of a user of the client device, and historic correspondence data of the user of the client device, and determining the identifier based on the score.

The following paragraphs (S1) through (S11) describe examples of systems and devices that may be implemented in accordance with the present disclosure.

(S1) A system may comprise at least one processor and at least one computer-readable medium encoded with instructions which, when executed by the at least one processor, cause the system to determine an identifier for at least one user based on contents of a file, the identifier being indicative of the at least one user being a potential recipient of the file, receive an input from a client device, the input indicative that the file is to be shared, and send data to the client device in response to receipt of the input so as to enable sharing of the file with use of the client device, the data including the identifier.

(S2) A system may be configured as described in paragraph (S1), and the at least one computer-readable medium may be encoded with additional instructions which, when executed by the at least one processor, further cause the system to receive, from the client device, the file, and generate an event indicating upload of the file to the system.

(S3) A system may be configured as described in paragraph (S1), wherein the identifier for the at least one user is determined in response to the event being generated.

(S4) A system may be configured as described in any of paragraphs (S1) through paragraph (S3), and the at least one computer-readable medium may be encoded with additional instructions which, when executed by the at least one processor, further cause the system to store metadata associating the at least one user identifier with the file, and retrieve the metadata after receipt of the input.

(S5) A system may be configured as described in any of paragraphs (S1) through (S4), and the at least one computer-readable medium may be encoded with additional instructions which, when executed by the at least one processor, further cause the system to determine text of the file, identify, from the text, one or more named entities corresponding to a person name or a team name, and determine the identifier based on the one or more named entities.

(S6) A system may be configured as described in any of paragraphs (S1) through (S5), and the at least one computer-readable medium may be encoded with additional instructions which, when executed by the at least one processor, further cause the system to identify one or more named entities from the contents of the file, send, to a database, a request for identifiers that match the one or more named entities, and in response to the request, receive, from the database, a list of identifiers including the identifier.

(S7) A system may be configured as described in any of paragraphs (S1) through (S6), and the at least one computer-readable medium may be encoded with additional instructions which, when executed by the at least one processor, further cause the system to determine a subset of identifiers from the list of identifiers based on an order of the list of identifiers.

(S8) A system may be configured as described in paragraph (S7), and the at least one computer-readable medium may be encoded with additional instructions which, when executed by the at least one processor, further cause the system to determine historic data for a user of the client device, the historic data including at least one recipient user that received a correspondence from the user, and determine the identifier based on the contents of the file and the historic data.

(S9) A system may be configured as described in any of paragraphs (S1) through (S8), and the at least one computer-readable medium may be encoded with additional instructions which, when executed by the at least one processor, further cause the system to identify an organization of at least one team name and one or more users associated with the organization, and determine the identifier based on the contents of the file, the organization, and the one or more users.

(S10) A system may be configured as described in any of paragraphs (S1) through (S9), and the at least one computer-readable medium may be encoded with additional instructions which, when executed by the at least one processor, further cause the system to determine a file type for the file, and determine the at least one user identifier based on the contents of the file and the file type.

(S11) A system may be configured as described in any of paragraphs (S1) through (S10), wherein the at least one computer-readable medium may be encoded with additional instruction which, when executed by the at least one processor, further cause the system to identify one or more named entities from the contents of the file, determine a list of identifiers matching the one or more named entities, determine a score for at least one identifier in the list of identifiers based on at least one of a characteristic of the file, a file type of the file, context for the one or more named entities, organization structure data for an organization of a user of the client device, and historic correspondence data of the user of the client device, and determine the at identifier based on the score.

The following paragraphs (CRM1) through (CRM11) describe examples of computer-readable media that may be implemented in accordance with the present disclosure.

(CRM1) At least one non-transitory computer-readable medium may be encoded with instructions which, when executed by at least one processor of a computing system, cause the computing system to determine an identifier for at least one user based on contents of a file, the identifier being indicative of the at least one user being a potential recipient of the file, receive an input from a client device, the input indicative that the file is to be shared, and send data to the client device in response to receipt of the input so as to enable sharing of the file with use of the client device, the data including the identifier.

(CRM2) At least one non-transitory computer-readable medium may be configured as described in paragraph (CRM1), and may be encoded with additional instruction which, when executed by the at least one processor, further cause the computing system to receive, from the client device, the file, and generate an event indicating upload of the file to the computing system.

(CRM3) At least one non-transitory computer-readable medium may be configured as described in paragraph (CRM2), wherein the identifier for the at least one user is determined in response to the event being generated.

(CRM4) At least one non-transitory computer-readable medium may be configured as described in any of paragraphs (CRM1) through (CRM3), and may be encoded with additional instruction which, when executed by the at least one processor, further cause the computing system to store metadata associating the at least one user identifier with the file, and retrieve the metadata after receipt of the input.

(CRM5) At least one non-transitory computer-readable medium may be configured as described in any of paragraphs (CRM1) through (CRM4), and may be encoded with additional instruction which, when executed by the at least one processor, further cause the computing system to determine text for the file, identify, from the text, one or more named entities corresponding to a person name or a team name, and determine the identifier based on the one or more named entities.

(CRM6) At least one non-transitory computer-readable medium may be configured as described in any of paragraphs (CRM1) through (CRM5), and may be encoded with additional instruction which, when executed by the at least one processor, further cause the computing system to identify one or more named entities from the contents of the file, send, to a database, a request for identifiers that match the one or more named entities, and in response to the request, receive, from the database, a list of identifiers including the identifier.

(CRM7) At least one non-transitory computer-readable medium may be configured as described in any of paragraphs (CRM1) through (CRM6), and may be encoded with additional instruction which, when executed by the at least one processor, further cause the computing system to determine a subset of identifiers from the list of identifiers based on an order of the list of identifiers.

(CRM8) At least one non-transitory computer-readable medium may be configured as described in any of paragraphs (CRM1) through (CRM7), and may be encoded with additional instruction which, when executed by the at least one processor, further cause the computing system to determine historic data for a user of the client device, the historic data including at least one recipient user that received a correspondence from the user, and determine the at least one user identifier based on the contents of the file and the historic data.

(CRM9) At least one non-transitory computer-readable medium may be configured as described in any of paragraphs (CRM1) through (CRM8), and may be encoded with additional instruction which, when executed by the at least one processor, further cause the computing system to identify an organization of at least one team name and one or more users associated with the organization, and determine the identifier based on the contents of the file, the organization, and the one or more users.

(CRM10) At least one non-transitory computer-readable medium may be configured as described in any of paragraphs (CRM1) through (CRM9), and may be encoded with additional instruction which, when executed by the at least one processor, further cause the computing system to determine a file type for the file, and determine the at least one user identifier based on the contents of the file and the file type.

(CRM11) At least one non-transitory computer-readable medium may be configured as described in any of paragraphs (CRM1) through (CRM10), and may be encoded with additional instruction which, when executed by the at least one processor, further cause the computing system to identify one or more named entities from the contents of the file, determine a list of identifiers matching the one or more named entities, determine a score for at least one identifier in the list of identifiers based on at least one of a characteristic of the file, a file type of the file, context for the one or more named entities, organization structure data for an organization of a user of the client device, and historic correspondence data of the user of the client device, and determine the identifier based on the score.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method, comprising:
determining, by a computing system, a file type for a file;
determining a data extraction method based on the file type and a file structure of the file;
determining user information data from the file using the data extraction method;
determining, by the computing system and based on the user information data, least one potential recipient of the file;
receiving, by the computing system, an input from a client device, the input indicative that the file is to be shared; and
sending, by the computing system, data indicative of the at least one potential recipient to the client device in response to receipt of the input so as to enable sharing of the file with use of the client device.

2. The method of claim 1, further comprising:
receiving, by the computing system and from the client device, the file; and
generating, by the computing system, an event indicating upload of the file to the computing system.

3. The method of claim 2, further comprising:
determining, by the computing system and from the user information data, a contact identifier for the at least one potential recipient, wherein the contact identifier for the at least one potential recipient is determined in response to the event being generated.

4. The method of claim 1, further comprising:
storing, by the computing system, metadata associating the at least one potential recipient with the file; and
retrieving the metadata after receipt of the input.

5. The method of claim 1, further comprising:
determining text of the file;
identifying, from the text, one or more named entities corresponding to a person name or a team name; and
determining the at least one potential recipient based on the one or more named entities.

6. The method of claim 1, further comprising:
identifying, by the computing system, one or more named entities from contents of the file;
sending, to a database, a request for identifiers that match the one or more named entities; and
in response to the request, receiving, from the database, a list of identifiers including an identifier of the at least one potential recipient.

7. The method of claim 6 further comprising:
determining, by the computing system, a subset of identifiers from the list of identifiers based on an order of the list of identifiers.

8. The method of claim 1, further comprising:
determining, by the computing system, historic data for an owner of the file, the historic data including at least one recipient user that received a correspondence from the at least one potential recipient; and
determining, by the computing system, the at least one potential recipient based on contents of the file and the historic data.

9. The method of claim 1, further comprising:
identifying, by the computing system, at least one team name and one or more users associated with an organization; and
determining, by the computing system, the at least one potential recipient based on contents of the file, the at least one team name, and the one or more users.

10. (canceled)

11. The method of claim 1, further comprising:
identifying, by the computing system, one or more named entities from contents of the file;
determining, by the computing system, a list of identifiers matching the one or more named entities;
determining a score for at least one identifier in the list of identifiers based on at least one of a characteristic of the file, the file type of the file, context for the one or more named entities, organization structure data for an organization of a user of the client device, and historic correspondence data of the user of the client device; and
determining the at least one potential recipient based on the score.

12. A system comprising:
at least one processor; and
at least one computer-readable medium encoded with instructions which, when executed by the at least one processor, cause the system to:
determine a file type for a file;
determine a data extraction method based on the file type and a file structure of the file;
determine user information data from the file using the data extraction method;
determine, based on the user information data, at least one potential recipient of the file;
receive, from a client device, an input indicative of that the file is to be shared; and
send data indicative of the at least one potential recipient to the client device in response to receipt of the input so as to enable sharing of the file with use of the client device.

13. The system of claim 12, wherein the at least one computer-readable medium is encoded with additional instructions which, when executed by the at least one processor, further cause the system to:
receive, from the client device, the file; and
generate an event indicating upload of the file the system.

14. The system of claim 12, wherein the at least one computer-readable medium is encoded with additional instructions which, when executed by the at least one processor, further cause the system to:
store metadata associating the at least one potential recipient with the file; and
retrieve the metadata after receipt of the input.

15. The system of claim 12, wherein the at least one computer-readable medium is encoded with additional instructions which, when executed by the at least one processor, further cause the system to:
determine text of the file;
identify, from the text, one or more named entities corresponding to a person name or a team name; and
determine the at least one potential recipient based on the one or more named entities.

16. The system of claim 12, wherein the at least one computer-readable medium is encoded with additional instructions which, when executed by the at least one processor, further cause the system to:
identify one or more named entities from contents of the file;
send, to a database, a request for identifiers matching the one or more named entities; and
in response to the request, receive, from the database, a list of identifiers including an identifier of the at least one potential recipient.

17. The system of claim 16, wherein the at least one computer-readable medium is encoded with additional instructions which, when executed by the at least one processor, further cause the system to:
determine a subset of identifiers from the list of identifiers based on an order of the list of identifiers.

18. The system of claim 12, wherein the at least one computer-readable medium is encoded with additional instructions which, when executed by the at least one processor, further cause the system to:
determine historic data for an owner of the file, the historic data including at least one recipient user that received a correspondence from the at least one potential recipient; and
determine the at least one potential recipient based on contents of the file and the historic data.

19. The system of claim 12, wherein the at least one computer-readable medium is encoded with additional instructions which, when executed by the at least one processor, further cause the system to:
identify at least one team name and one or more users associated with an organization; and
determine the at least one potential recipient based on contents of the file and the at least one team name, and the one or more users.

20. At least one non-transitory computer-readable medium encoded with instructions which, when executed by at least one processor of a computing system, cause the computing system to:
determine, by the computing system, a file type for a file;
determine a data extraction method based on the file type and a file structure of the file;
determine user information data from the file using the data extraction method;
determine, based on the user information data, at least one potential recipient of the file;
receive an input from a client device, the input indicative that the file is to be shared; and
send data indicative of the at least one potential recipient to the client device in response to receipt of the input so as to enable sharing of the file with use of the client device.

21. The system of claim 12, wherein the at least one computer-readable medium is encoded with additional instructions which, when executed by the at least one processor, further cause the system to:
identify one or more named entities from contents of the file;
determine a list of identifiers matching the one or more named entities;
determine a score for at least one identifier in the list of identifiers based on at least one of a characteristic of the file, the file type of the file, context for the one or more named entities, organization structure data for an organization of a user of the client device, and historic correspondence data of the user of the client device; and
determine the at least one potential recipient based on the score.
